(19) United States
(12) Patent Application Publication
(10) Pub. No.: US 2003/0018752 A1
(43) Pub. Date: Jan. 23, 2003

(54) System and method for embedding a message in a uniform resource locator

(76) Inventor: David Lowy, Toronto (CA)

Correspondence Address: Mark B. Eisen, Dimock Stratton Clarizio, 20 Queen Street West, Suite 3202, Box 102, Toronto, ON, M5H 3R3, CA

(21) Appl. No.: 10/193,256

(22) Filed: Jul. 12, 2002

Related U.S. Application Data
(60) Provisional application No. 60/305,901, filed on Jul. 18, 2001.

(51) Int. Cl. G06F 15/16

(52) U.S. Cl. 709/219

(57) ABSTRACT

A system and method for embedding an arbitrary text message in a uniform resource identifier (URI) or in portions of a web page for display in a user agent such as a web browser. The message is transmitted automatically when the URI is requested by a user agent. A message administration system, in communication with a message filter system, intervenes in a user agent request for the URI to embed the text message into a selected portion of the URI and forwards the web page with the modified URI to the requesting user agent. The message administration system can further intervene in a user agent request to embed the text message into the title bar of a requested web page. The message administration system tracks the insertion of text messages and the receipt of requests containing embedded text messages.

### FIELD OF THE INVENTION

This invention relates to online advertising on a global computer network such as the Internet, and in particular, the display of text messages in a user's web browser over a computer network.

### BACKGROUND OF THE INVENTION

Displaying advertisements within the content of a web page on a website on the World Wide Web has become an accepted practice. It is common for these advertisements to be targeted to an appropriate potential customer base so that users of the web page see advertisements for items that would likely interest them. It is also common to eliminate the duplication of advertisements during a user's visit to the website through a system of advertisement rotation.

The format of an advertisement used on a web page may also be changed to make the advertisement appear different from other advertisements previously used on the web page, as well as other advertisements displayed on the same web page. Common online advertising formats include buttons, banners, tiles and sponsorships. Banners are typically 468 pixels wide×60 pixels high so that they fit in their entirety on a user's computer monitor when a web page is viewed. Buttons and other graphics such as tiles are even smaller. Sponsorships are often text-based advertisements that are placed at the top of a web page.

All these advertising formats may be interactive. If a user wants to find out more information about an advertisement on a web page, he or she can click the advertisement with the mouse or other pointing device used to operate the user's web browser. This clicking action causes an HTTP request to be created by the user's browser, resulting in the display of a new web page from the web server either in the same browser window or in a new browser window. This new web page may be a page from the advertiser's web site, or another web page with more information about the advertisement. On this page, the user is typically invited to respond further to the advertisement; for example, by making a purchase or registering his or her name and address. The user's reaction to the advertising, by clicking on the initial advertisement, may also be recorded by the web server responsible for placing the advertisement on the web page. This allows advertisers to determine the effectiveness of their ads.

Due to the proliferation of online advertising, a user may view a large number of advertisements on a given web page. Although a web page may be of any size, the user may not be inclined to view the entire contents of a page. Therefore, the most coveted advertising space on a web page is located “above the fold”, or in other words, in the space of a web page which is immediately viewable when the web page is loaded in a web browser window, without any need on the part of the user to scroll down the page. However, the portion of the page “above the fold” is of limited size.

Furthermore, owners of websites often wish to track the usage of their web pages. Currently, computer programs resident on a web server log the http requests and other information sent by a user's browser when requesting a web page from the web server. These computer programs can provide statistics regarding the type of operating system employed by the user or the type of web browser employed, for example. Where the web browser transmits a request to a web server as a result of a user activating a hyperlink on a web page, the computer program may log the web page which contained the hyperlink. However, the logs recorded by such computer programs are not always accurate because they record only those requests which are transmitted to the web server. For example, a user visiting a website may visit a succession of pages; from a main page, the user may activate a hyperlink which requests a second page from the web server, then from the second page, the user may activate a further hyperlink which requests a third page. The computer program logging this activity would thus record that the user had requested the third page from the hyperlink on the second page. However, if the user used a “back” button on his or her web browser to return to the main page, the computer program would not be aware of this because no request would have been transmitted to the web server. Any further logging of user requests to the web server would therefore be inaccurate, as the computer program would inaccurately log requests as coming from hyperlinks on the second page, instead of the main page.

Therefore, it is desirable to identify other means and locations in a web browser by which an advertisement may be displayed to the user, which may furthermore be used to gather information about the user and track the means and frequency of display of an advertisement to a user. It is also desirable to provide a more accurate means of tracking a user's visit to a website.

### SUMMARY OF THE INVENTION

The invention provides a system and method for embedding an arbitrary text message, for example advertising, in a uniform resource identifier (URI) and, optionally, in the title bar of a web browser. The message is transmitted automatically when the URI is requested by a user agent, and thus ensures that the message in the URI or in the title bar, if this option is selected, is immediately viewable when the web page is loaded. The invention thus provides a mechanism for generating effective “impressions” each time a web page is selected, without taking up any space on the web page itself and irrespective of the type of browser, or computer system, from which the web page request was issued, or the content of the web page itself.

The invention accomplishes this by interposing a message into a portion of the URI, as the request for the URI is being processed. A message administration system in communication with a message filter system intervenes to embed the text message into a selected portion of the URI, and forwards the web page with the modified URI to the requesting user agent. By the same means, the invention provides a mechanism for insertion of a text message in the title bar of a web page. The invention further provides a system and method to remove embedded text messages from URIs and title bars of web browsers.

### BRIEF DESCRIPTION OF THE DRAWINGS

In drawings which illustrate by way of example only a preferred embodiment of the invention,

FIG. 1 is a schematic diagram of a computer network in a preferred embodiment of the invention.

FIG. 2 is a schematic diagram of the message filter system shown in FIG. 1.

FIG. 3 is a block diagram of a record from the message list of FIG. 2.

### DETAILED DESCRIPTION OF THE INVENTION

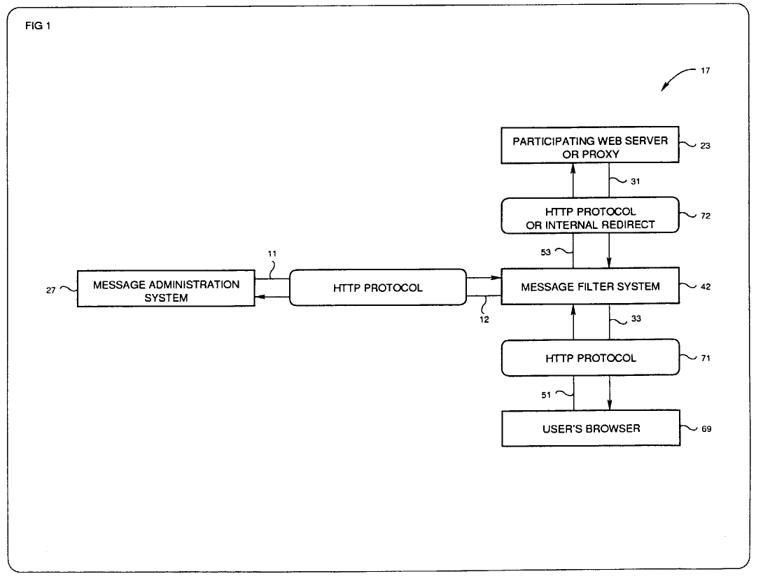

Referring to FIG. 1, the basic architecture of the computer network in a preferred embodiment of the present invention includes a message administration system 27, a message filter system 42, a participating web server or proxy 23, and a user agent 69. The user agent 69 is typically a web browser such as Netscape Navigator (Trademark) or Microsoft Internet Explorer (Trademark). The participating web server or proxy 23 is a program, which awaits and fulfils requests for web pages from clients such as the user agent 69. The participating web server or proxy 23 is a “participating” web server or proxy in that it is recognized by the message filter system as having files eligible for the delivery of text messages contemplated in the present invention, as described below. For the remainder of this document we will refer to this component as a participating web server, although it will be understood that the participating web server 23 includes a proxy program.

Interposed between the user agent 69 and the participating web server 23 is the message filter system 42, described in more detail below. The message filter system 42 communicates with the user agent 69, using HTTP protocol or another protocol 71, known in the art. Communication from the user agent 69 to the message filter system typically takes the form of a request as defined by the protocol 71, as indicated by arrow 51. Communication from the message filter system 42 to the user agent 69 typically takes the form of instructions or other data 33 as defined by the protocol 71.

Similarly, the message filter system 42 communicates with the participating web server 23 using a protocol or an internal redirect system 72, also known in the relevant art. The message filter system 42 sends requests 53 to the participating web server 23, and receives responses 31 from the participating web server 23. The message filter system 42 also communicates using a protocol with the message administration system 27.

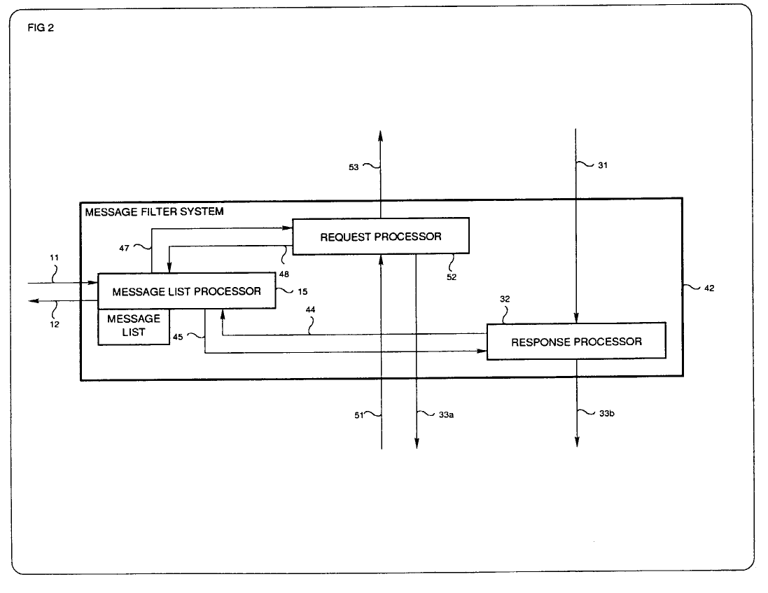

Referring to FIG. 2, the message filter system 42 comprises three blocks: a request processor 52, a response processor 32, and a message list processor 15. The request processor 52 receives requests 51 from the user agent 69, and transmits requests 53 to the participating web server 23. The request processor 52 further transmits a portion of the instructions and data, indicated as 33a, to the user agent 69. The response processor 32 receives data, typically in the form of a response 31, from the participating web server 23, and transmits data 33b to the user agent 69. The response processor 32 also transmits notification data 44 to the message list processor 15, and receives data 45 from the message list processor 15. The message list processor 15 receives data 48 from the request processor 52, as well as data 11 from the message administration system 27. The message list processor 15 transmits data 47 to the request processor 52 and data 12 to the message administration system 27. The message filter system 42 permits the display of text messages.

The text messages may be displayed in a number of locations supported by the user agent 69. For example, a text message may be inserted in the URI display field of the user agent 69. In one embodiment, the text message may be inserted as part of the file name of the document identified by the request 51 delivered from the user agent 60. In another embodiment, the text message may be inserted as part of the host name of the document identified by the request 51. Locations where the text message may be inserted may further include the authentication information or the query string, any combination of the above locations. The format of the text messages comprises a standardized coding which permits the system of the present invention to identify the text messages as recognized text messages; for example, the standardized coding may comprise leading and trailing characters. The standardized coding may be altered periodically as required.

The message list processor 15 is responsible for communicating with both the request 52 and response 32 processors, providing text messages based on metrics, and storing information as to how these messages were used. The message list processor 15 comprises a number of records, each of which corresponds to a text message stored in the message administration system.

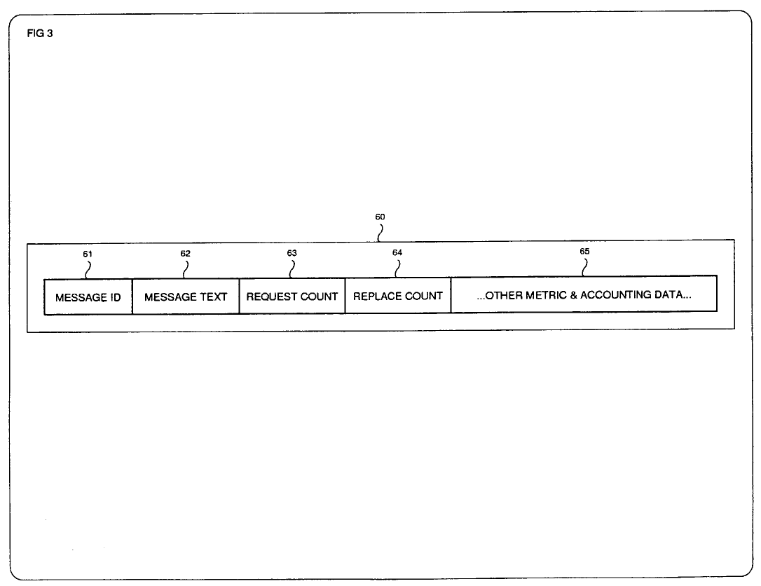

Referring to FIG. 3, each record 60 includes a number of fields: a message ID field 61, a text message field 62 for storing a text message, a request count 63, a replace count 64, and a field for other metric and accounting data 65. Every text message stored in the text message field 62 of a record 60 is assigned a unique identification number, stored in the message ID field 61. The request count field 63 records the number of requests made for a URI containing the corresponding text message, and the replace count field 64 tracks the number of times the corresponding text message is inserted in a URI. The metric and accounting data field 65 tracks the use of the corresponding text message stored in the text message field 62 for the purpose of recording the cost of advertising. For example, the accounting field 65 may track the occurrences of certain events, such as the number of times the text message is downloaded by a user requesting a web page; the number of times a user clicks on a text message by clicking on a displayed URI within a web page or in an electronic mail message; or the number of times a displayed URI is copied by a user and sent to another user. The accounting field 65 may also track such factors about the web page as site category, advertisement category, time of day, location of the user requesting a web page, the type of user agent used to request a web page, the location of the participating web server, and the number of other advertisements displayed on a requested web page. In a preferred embodiment, the data contained in the accounting field 65 further tracks the occurrence of events such as a “mouseover”, when the user moves the cursor of a pointing device over a hyperlink embedded in a web page.

When the message filter system 42 is not in place, requests 51 for web pages by the user agent 69 are directed to the web server 23. The web server 23 delivers the file identified by the URI in the request 51 to the user agent 69, and in the user agent display (not shown) the user is normally shown the URI requested or a portion thereof. In operation with the message filter system 42 of the invention in operation, the present invention augments the display of the URI by the user agent 69 to the user by incorporating a text message into the displayed URI. Subsequent usage of the augmented URI by the user is handled by the message filter system 42 as described below.

Referring to FIGS. 1 and 2, in the preferred embodiment of the invention, when a user agent makes a request 51 for a URI the request is transmitted to the request processor 52. If the URI incorporated into this request 51 does not include a text message, then the request processor 52 either forwards the request 51 directly as request 53, or inserts a message selected by the message list processor 15 from a record 60 into the URI of the request 51. The text message is selected from a record 60 according to the metrics contained in the metric and accounting data field 65. The request processor 52 then transmits instructions 33a to the user agent 69 to make a second request for this modified URI. The request processor 52 will only add a text message from a record 60 to a requested URI that is typically displayed to the user by the user agent 69. Preferably, the URIs that are modified to to include messages, comprise URIs which refer to HTML documents and not graphical images. The request processor 52 may also directly forward requests 51 for “home pages”, such as the main page of a web site resident on a participating web server 23, to be forwarded 53 to the participating web server 23, in order to minimize the amount of time required to process request 51.

The URI incorporated into a request 51 may already include a text message if the URI had previously been displayed to the user or cached by the user agent 69 in conjunction with a text message. If a recognized text message is included in the request 51, the request processor 52 sends data 48 to the message list processor 15 indicating that a particular recognized message has been received as part of a request 51. This event is recorded in the metrics field 65 of the record 60 corresponding to the recognized text message. The request processor 52 then removes the message from the URI received as request 51, thus modifying the request 51, and transmits this modified request as request 53 to the participating web server 23.

If the request processor 52 receives an initial request 51 from the user agent 69, which does not include a text message, then the request processor 52 will transmit instructions 33a to the user agent 69 instructing the user agent 69 to transmit a second request 51 which does include an inserted message from the message list processor 15. The message is selected by the message list processor 15 from a record 60, based on the accounting and metrics data contained in the metrics field 65. The initial request 51 is not transmitted by the request processor 52 to the participating web server 23, but the second request 51, after the message has been removed, is transmitted to the participating web server 23 as request 53.

The participating web server 23 receives and processes the request 53. A response 31 from the participating web server 23 is transmitted to the response processor 32. If the response processor 32 determines that any of the content of the response 31 includes URIs which refer to a participating web server 23, then those URIs may be modified to include messages selected from records 60 of the message list processor 15. The response processor 32 sends notification 44 to the message list processor 15 that a URI has been modified, and transmits the response to the user agent 69 as response 33b.

The response processor 32 modifies only those URIs in responses 31 where the URI may be displayed to the user by the user agent 69. URIs are modified when they refer to documents on the current participating web server 23; when they refer to documents on another web server that is known to support the system of the invention; or when the URI is a link to another web site that is not known to have the system of the invention on its web server (a “non-participating” web site). In the latter case, the URI in the response 31 is modified to be a link to the participating web server 23 which includes a message to be displayed by the user agent 69, and instructions for the request processor 52 to redirect the user agent 69 to this nonparticipating web site when a request 51 containing a URI corresponding to this nonparticipating web site is received.

In the system of message insertion described above, it will be understood that the system both causes the insertion of messages in URIs displayed to the user, and receives requests 51 from the user agent 69 which contain such inserted messages. Because the messages are embedded in a recognized format, the system may track the number of times that a particular message is embedded in a URI, either by the system itself, or in a request 51 received from a user agent 69. The system may track these uses of the text messages in the accounting and metrics field 65. In a preferred embodiment of the invention, the system further allows for display of inserted text messages in other portions of the user agent 69. For example, the system may alter the content of a web page to insert a text message within the title of the web page, commonly denoted by the HTML tag <title></title>. In this case, only the insertion of the text message is recorded by the message list processor 15 in the metrics and accounting field 65. Ideally, the system may insert javascript code into the web page to allow the system to track “mouseover” events, as described above, and the message list processor 15 would then record the “mouseover” events and the insertion of the code in the metrics and accounting field 65.

In order to track and control the display of the text messages from the message list processor 15, a number of credits may be stored in the accounting field 65. Each time the corresponding text message in that record 60 is displayed, the number of credits in the accounting field 65 is diminished according to the combination of events and factors. When no credits are left, the text message is no longer served out and is said to be expired. However, the messages within the URIs may still be cached by the user; for example, if the user has “bookmarked” the URI using a web browser for future reference, or saved the URI within an electronic mail message. If this is the case, then the message filter system 42 may log requests for expired text messages separately from requests for non-expired messages, in order to track the lifecycle of the expired text message.

This system and method for embedding a message in a URI may further be used to track the number and strength of impressions a text message receives. When a first user receives a URI with an embedded message, the delivery of this embedded message (an impression) is recorded by the message list processor 15 as described above. When the first user initiates a request 51 via the user agent 69 incorporating a URI with an embedded message, the message list processor 15 records this further impression, also as described above. The first user may also send the URI, together with the embedded text, to a second user. This event will not be recorded by the message list processor 15; however, if this second user initiates a request 51 for the URI with his or her own user agent 69, then the message list processor 15 will be able to record this impression.

In a further embodiment, the system provides an alternate means of communicating data between participating web servers 23. A URI contained within a web page, which points to a web page on another participating web server 23, is modified by the system to include an embedded text message, in the manner described above. When the user agent 69 transmits a request 51 for this URI, this request 51 will include the embedded text message. The message filter system 42 of the receiving participating web server 23 records the receipt of the embedded text message, and optionally transmits the data contained within the embedded text message to the receiving participating web server 23.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A method of embedding a text message in a universal resource identifier, comprising the steps of
a. receiving a request for a universal resource identifier issued by a user agent,
b. interposing a text message into a selected portion of the universal resource identifier to generate a modified universal resource identifier, and
c. forwarding a web page associated with the universal resource identifier along with the modified the universal resource identifier to the user agent.

2. A system for embedding a text message in a universal resource identifier, comprising
a message filter for receiving a request for a universal resource identifier issued by a user agent,
a message administrator for interposing a text message into a selected portion of the universal resource identifier to generate a modified universal resource identifier, and
a response processor for forwarding a web page associated with the universal resource identifier along with the modified the universal resource identifier to the user agent.

3. A system for embedding a text message in the title bar of a web page, comprising
a message filter for receiving a request for a web page issued by a user agent,
a message administrator for interposing a text message into a selected portion of the web page to generate a modified web page title, and
a response processor for forwarding the web page with a modified titleto the user agent.

4. A method for removing embedded text messages from a response to a request for a universal resource indicator, comprising the steps of
a. receiving a response to a request for a universal resource indicator from a participating web server, the response comprising an embedded text message;
b. removing the embedded text message from the response; and
c. forwarding the response to a user agent.

5. A system for tracking requests issued by a user agent, comprising
a message filter for receiving a request for a modified universal resource identifier comprising an embedded text message, and optionally extracting the embedded text message from the modified universal resource identifier,
a message administrator for logging the receipt of the request for a modified universal resource indentifier, and
a response processor for forwarding a web page associated with the modified universal resource identifier.
